(19) United States
(12) Patent Application Publication
(10) Pub. No.: US 2009/0083642 A1
(43) Pub. Date: Mar. 26, 2009

(54) METHOD FOR PROVIDING GRAPHIC USER INTERFACE (GUI) TO DISPLAY OTHER CONTENTS RELATED TO CONTENT BEING CURRENTLY GENERATED, AND A MULTIMEDIA APPARATUS APPLYING THE SAME

(75) Inventors: Hyun-jin KIM, Seoul (KR); Ji-hyeon KWEON, Yongin-si (KR); Yong-gook PARK, Yongin-si (KR); Myung-hyun YOO, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/031,159

(22) Filed: Feb. 14, 2008

(30) Foreign Application Priority Data
Sep. 21, 2007 (KR) 2007-97013

(51) Int. Cl. G06F 3/048

(52) U.S. Cl. 715/762

(57) ABSTRACT

A method for providing a graphic user interface (GUI) and a multimedia apparatus incorporating the same. While a first content is being generated, other content related to the first content are searched for via a storage medium or a network and displayed concurrently. As a result, a user can view the related content conveniently while the user is generating or editing content.

### CROSS-REFERENCE TO RELATED APPLICATION

This application claims the benefit of Korean Application No. 2007-97013, filed in the Korean Intellectual Property Office on Sep. 21, 2007, the disclosure of which is incorporated herein by reference.

### BACKGROUND OF THE INVENTION

1. Field of the Invention

Aspects of the present invention relate generally to a method for providing a graphical user interface (GUI) and a multimedia apparatus applying the same, and more particularly, to a method for providing a GUI for content being currently generated and a multimedia apparatus applying the same.

2. Related Art

The advent of user created content (UCC) has enabled users to create content and share the content with each other, and has now become an important part of web services. The UCC is shifting from a limited content generating tool to a multi-way content generating tool that enables users not only to create content, but also to receive content of other users or services, and to reconstruct or edit the received content.

Following the recent technical development and diversification of web services, content as the subject of the UCC has diversified as well. The content may include photographs, background music, video, or text. A user who generates content may have one or two original content sources, and search and add other content sources, such as background music to play along with the text, or a film teaser to go along with a film review.

Many users who want to publish their content would want to make sure that their content is unique and that there are no other users who have similar content. The users would also want to take elements from the content generated by other users and add these elements to their content. Therefore, many users search other user's content by keywords such as subject of the text or title of the photos, and utilize the content even though the process is quite cumbersome. Users would also want to delete or change their content when they find that the similar content has already been created by others. Essentially, many users want to generate more unique content. Therefore, a method that enables the users to conveniently access other content related to the content they are generating would be helpful to users.

### SUMMARY OF THE INVENTION

Aspects of the present invention provide a method for providing a graphic user interface (GUI) to display other contents related to the content currently being generated so that a user can check the related content conveniently while generating content, and a multimedia apparatus applying the same.

According to an aspect of the present invention, a multimedia apparatus is provided. The apparatus includes a display unit to display multimedia information, including a first information window to display first multimedia information and a second information window to display second multimedia information, a control unit to search for the second multimedia information as the related information of the first multimedia information and to display the second multimedia information on the second information window while a user edits or generates the first multimedia information, and a storage unit to store the multimedia information.

According to another aspect of the present invention, the first multimedia information and the second multimedia information comprise at least one of still image, video, audio, or text.

According to another aspect of the present invention, the second information window displays attribute data to represent attributes of the multimedia information.

According to another aspect of the present invention, the control unit adds the second multimedia information to the first multimedia information according to a control command of the user.

According to another aspect of the present invention, a multimedia apparatus is provided. The apparatus includes a display unit to display multimedia information, including a first information window to display first multimedia information and a second information window to display second multimedia information related to the first multimedia information, a network interface unit connectable to a network, a control unit to search for the second multimedia information, which is related to the first multimedia information, through the network interface unit, and to display the second multimedia information on the second information window while a user edits or generates the first multimedia information, and a storage unit to store the multimedia information.

According to another aspect of the present invention, the control unit includes a search engine unit to search for the second multimedia information.

According to another aspect of the present invention, a method of providing a graphic user interface (GUI) to display multimedia information is provided. The method includes displaying a first information display region to display first multimedia information; displaying a second information display region to display at least one second multimedia information related to the first multimedia information while a user edits the first multimedia information; and displaying the at least one second multimedia information on the second information display region.

According to another aspect of the present invention, a method for displaying multimedia information is provided. The method includes displaying first multimedia information on a first information display region, searching for second multimedia information related to the first multimedia information while a user edits the first multimedia information, and displaying the second multimedia information on a second information display region.

According to another aspect of the present invention, a method for providing a graphic user interface (GUI) is provided. The method includes generating first content, searching for content related to the first content via a storage medium or through a network, while the first content is being generated, and displaying the related content while the first content is being generated.

According to another aspect of the present invention, the displaying includes displaying the first content currently being generated along with the related content on the same screen.

According to another aspect of the present invention, the searching includes categorizing the related content obtained from the storage medium or through the network into content types and determining content relevant to the first content in each content type.

According to another aspect of the present invention, the searching includes searching for the related content via the storage medium or the network after a predetermined interval.

According to another aspect of the present invention, the displaying includes categorizing the searched related contents according to content types.

According to another aspect of the present invention, the searching includes searching for the related content via the storage medium or the network using a keyword or attribute data of the first content.

According to another aspect of the present invention, if the first content is a photograph or video, the searching includes searching for the related content via the storage medium or the network, using image characteristic data including at least one of brightness, color, area matching, or feel of material.

According to another aspect of the present invention, if the related content is photographs, the displaying includes displaying related thumbnails corresponding to the related content.

According to another aspect of the present invention, a multimedia apparatus is provided. The apparatus includes a network interface unit connectable to a network, a storage unit to store a multimedia file, and a control unit to display first content concurrently with contents related to the first content currently being generated, via the storage unit or the network connected through the network interface.

According to another aspect of the present invention, the control unit displays the related content on the same screen as the first content that is currently being generated.

According to another aspect of the present invention, the control unit searches for the related content by categorizing the related content obtained from the storage unit or the network according to content type and determining which of the related content is most relevant to the first content for each content type.

According to another aspect of the present invention, the control unit searches for the related content via the storage unit or the network after a predetermined time interval.

According to another aspect of the present invention, the control unit categorizes the related content according to content type and displays the result.

According to another aspect of the present invention, the control unit searches for the related content via the storage unit or the network using a keyword or attribute data of the first content.

According to another aspect of the present invention, if the first content is a photograph or video, the control unit searches for the related content via the storage medium or the network, using image characteristic data including at least one of brightness, color, area matching, or feel of material.

According to another aspect of the present invention, if the related content is photographs, the control unit displays related thumbnails corresponding to the related content.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects of the embodiments, taken in conjunction with the accompanying drawings of which:

FIG. 1 illustrates a multimedia system having a personal computer (PC) according to an embodiment of the present invention;

FIG. 2 is a block diagram of a PC according to an embodiment of the present invention;

FIG. 3 is a flowchart of a method for providing a graphic user interface (GUI) to display other content related to content currently being generated;

FIGS. 4A to 4C illustrate screens in which a content generating window and a related content window are displayed according to an embodiment of the present invention;

FIG. 5 illustrates an example of displaying other content related to the content being currently generated in a blog according to another embodiment of the present invention; and

FIG. 6 illustrates an example of displaying other content related to the digital camera photograph currently being viewed according to yet another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

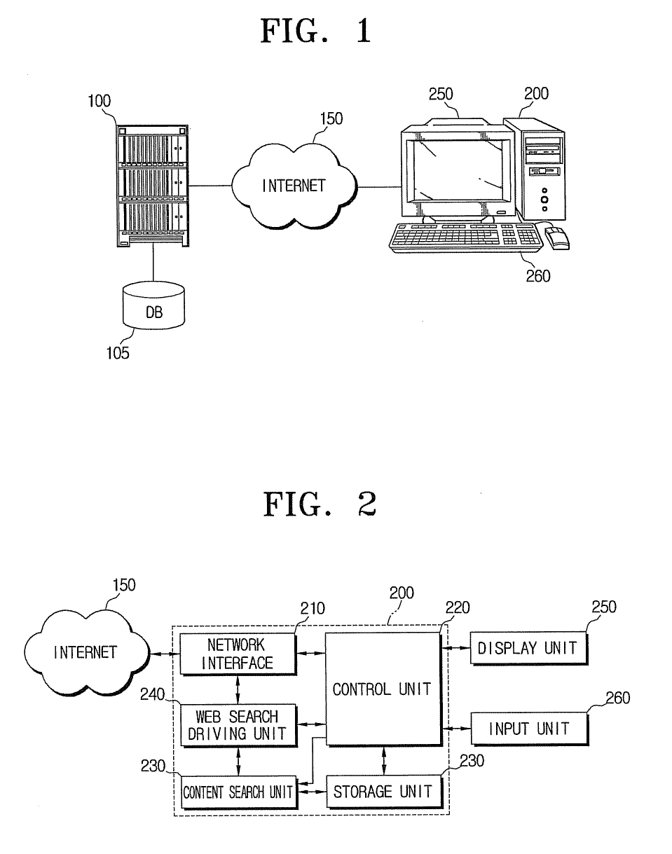

FIG. 1 shows a multimedia system having a personal computer 200 according to an embodiment of the present invention. The multimedia system, as shown in FIG. 1, includes the PC 200, a display unit 250, and an input unit 260. According to other aspects of the present invention, the multimedia system may include additional and/or different units. Similarly, the above units may be provided separately, or two or more of the above units may be integrated into a single component.

The PC 200 is connected to the Internet 150, and is used by a user to access via the Internet 150 the contents of a database (DB) 105 stored in an external server 100. The PC 200 may be any device connectable to a network.

The display unit 250 displays a video being output from the PC 200. The display unit 250 may display a first information window to display first multimedia information, and a second information window to display second multimedia information related to the first multimedia information. The first multimedia information may comprise content being generated by a user. The second multimedia information may include content related to the content being generated by the user. The first information window includes a screen area to display content being generated by the user. The second information window includes a screen area to display other content related to the content currently being generated by the user.

The input unit 260 receives a user command to operate the PC 200. The input unit may be any device capable of receiving input from a user, such as a keyboard, a mouse, a touchscreen, or a microphone.

The server 100 provides users with various services. In particular, the server 100 may provide services to enable the users to generate content. The server 100 stores in the DB 105 data to provide the users with the services. The DB 105 may also store content generated by the users; the content may also be stored in the PC 200 and accessible by the DB 105.

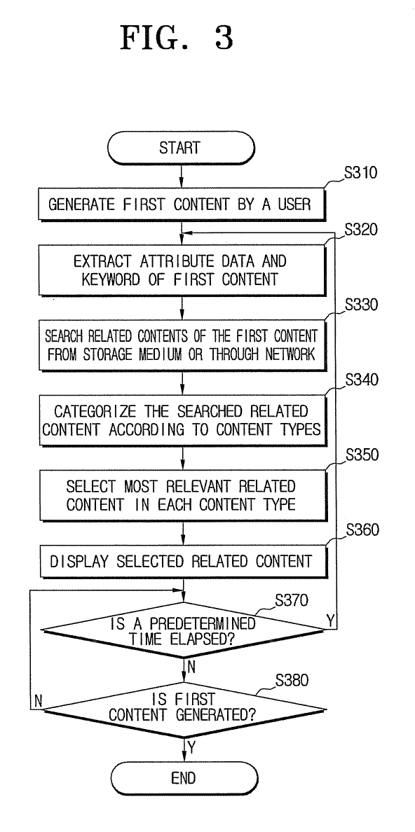

The multimedia system will be explained in detail below with reference to FIG. 2. FIG. 2 shows the PC 200 according to an embodiment of the present invention. The PC 200 includes a network interface 210, a central processing unit (CPU) 220, and a storage unit 230. According to other aspects of the invention, the PC 200 may include additional and/or different units. Similarly, the functionality of two or more of the above units may be integrated into a single component.

The network interface 210 connects the PC 200 to the Internet 150, and thus provides fast access and data exchange between the PC 200 and the Internet 150. The network interface 210 may connect the PC 200 not only to the Internet 150, but also to other external networks.

The storage unit 230 stores the files used in the PC 200. The storage unit 230 also stores the files related to the multimedia content. The files related to the multimedia content may include a document file, photograph file, video file, or music file.

A web search driving unit 240 drives the network interface 210 to start a multimedia information search through the Internet 150. A content search unit 245 searches for the related content from the multimedia content stored in the storage unit 230. The content searching unit 245 also requests the web search driving unit 240 for a web search to search for the multimedia information via the Internet 150.

The CPU 220 controls the overall operations of the PC 200. For example, the CPU 200 may cause the data input through the input unit 260 to be stored in the storage unit 230, or displayed on the display unit 250. The CPU 220 may also control the content search unit 245 to automatically search the storage unit 230 or the Internet 150 for other content related to the content (“first content”) currently being generated by a user. The CPU 220 also controls the display of the related content along with the first content being generated by the user. The CPU 220 controls the display unit 250 to display the first content and the searched content together on the same screen.

The CPU 220 categorizes the type of the first content and the related content and determines if there is content relevant to the first content in each content type. The content types may include document, photograph, video, music, or still image.

The CPU 220 may also control the content search unit 245 to search the related content via the storage unit 230 or the networks at certain time intervals. The certain time intervals may be 1 second, 10 seconds, or other intervals. The CPU 220 may also search for the related content each time the first content is input.

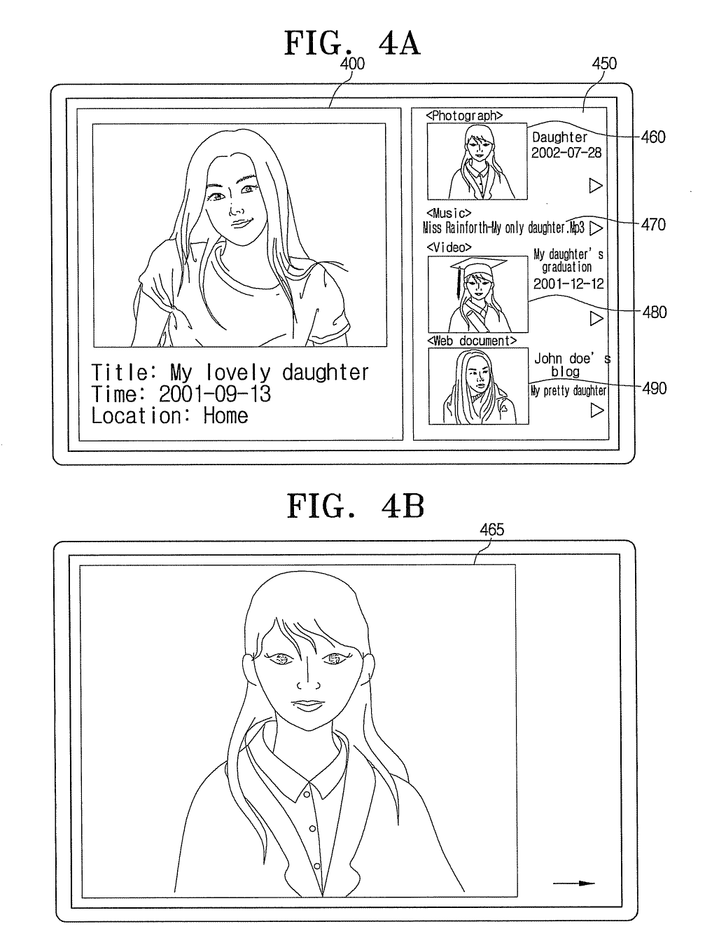

The operation of the CPU 220 will be explained in detail below with reference to FIG. 3. FIG. 3 shows a flowchart of a method for providing a GUI to display other content related to the content currently being generated.

In operation S310, a user generates first content. The first content may be composed of documents, photographs, videos, music, or any combination thereof. To “generate document content” indicates that a user writes a document, adds photographs, videos, or music to the document, or uploads the completed document. To “generate photo content” indicates that a user takes a photograph, uploads a photograph, or writes the title of a photograph. To “generate video content” indicates that a user shoots a video, uploads a video, or writes the title of a video. To “generate music content” indicates that a user records or uploads a music, or inputs a title or a singer of the music. However, the term ‘generate content’ is not limited to the examples explained above, but is applicable to the overall activities of a user to create any type of content.

In operation S320, the CPU 220 extracts attribute data and keywords of the first content while the first content is currently being generated. In operation S330, the CPU 220 searches for other content related to the first content from a storage medium or through a network. During the generation of the first content, the CPU 220 extracts the attribute data and the keyword of the first content and sends out a query to the Internet 150 via the network interface 210. In response to the query received over the Internet 150, the server 100 searches the DB 105 to send the content related to the attribute information and the keyword of the first content to the PC 200 over the Internet 150.

The attribute data of the first content may include a type of the document, type of service, time and date of photograph, or device information. The keyword of the first content may include a word extracted from the text being currently written by a user, title of the document or photograph, or title of music or video file.

For example, if the first content is a document, the attribute data may include a type of the document, such as a new article posted on a blog or posting board, or writer of the document, and the keyword may be a word extracted from the document or the title of the document. If the first content is a photograph, the attribute data may include a file type of the photograph, time or place of photograph, device type used in photographing, pixels, colors, brightness, area matching, feel of material, or photographer. The keyword may include a title or file name of the photograph, or keywords related to the subject of the photograph.

If the first content is video, the attribute data may include a file type of the video, time or place of taking the video, device type of a camcorder, pixels, colors, brightness, area matching, feel of material, video photographer, replay time, or video genre. The keyword may include a title or file name of the video. If the first content is music, the attribute data may include a file type of the music, time, or place of recording the music, sound quality, or tone. The keyword may include a title, singer, or album of the song, or file name.

The CPU 220 searches for related content of the first content, using the attribute data or keyword of the first content. For example, if the first content is a document, the CPU 220 performs the search in the same manner as the general web document search, and also searches other types of content, such as photographs, videos, or music.

For example, when the first content is photograph, the CPU 220 searches all the other related content, such as documents, videos, photograph and music files, using the title of the photograph as a keyword. The above also applies to other types of the first content. The related content is searched from among the same and different types of content based on the attribute data or the keyword.

If the first content includes photographs or videos, the related content may be searched for using characteristic information of the image. For example, if the first content includes photograph and video, the color distribution and brightness information may be compared to search for photographs or videos having a similar pattern. The content may also be searched for using a matching measure to compare the similarity between limited areas of photographs or videos.

The CPU 220 may search for the related content based on the structural information of the first content. In this case, the currently generating web document is compared with the other web documents based on the multimedia type of the currently generating web document and a layout of the document, to find web documents related to the currently generating web document. For example, if the user is in the process of uploading a photograph on a posting board along with a comment underneath the photograph, the CPU 220 extracts the uploaded photograph, the attribute data of the photograph, and the keyword of the comment, and selects the other web documents that have the similar pattern having photograph and comment written under the photograph.

The CPU 220 searches the content related to the first content from the storage medium or through a network in the manner as explained above.

In operation S340, the CPU 220 categorizes the related content according to type. In operation S350, the CPU 220 selects the most-relevant content from each of the type categories. In operation S360, the CPU 220 displays the selected most-relevant content.

A variety of measures may be used to select the most-relevant content from among the related content. For example, the order of similarity may be determined based on the attribute data, keyword, and document, using Extended Boolean Model, MMM Model, Paice Model, or P-norm Mode. If a photograph is compared to match the currently generating content and the related content, related content may be determined as the most-relevant content if the related content has a color of a photograph most similar to that of the currently generating content. As a result, the CPU 220 is able to select the most-relevant content from among the related content and display the result.

In operation S370, the CPU 220 determines whether a predetermined time has elapsed. In operation S370-Y, upon determining that the predetermined time has elapsed, the CPU 220 goes back to operation S320 to search the content related to the first content again so that the related content can be continuously searched in real time based on the content being currently generated by a user. For example, the search for the related content can be set to repeat once every minute.

In operation S370-N, upon determining that the predetermined time has not elapsed, the CPU 220 determines whether the generation of the first content is completed in operation S380. In operation S380-N, upon determining that the generation of the first content is not completed, the CPU 220 waits until a predetermined time interval expires. In operation S380-Y, upon determining that the generation of the first content is completed, the CPU 220 finishes searching the related content.

The procedure for searching the related contents of the first content being currently generated by a user has been explained with reference to FIG. 3. While the related content is searched for periodically according to a predetermined time period, other techniques are possible. For example, the related content may be searched for each time the currently generated content is being edited.

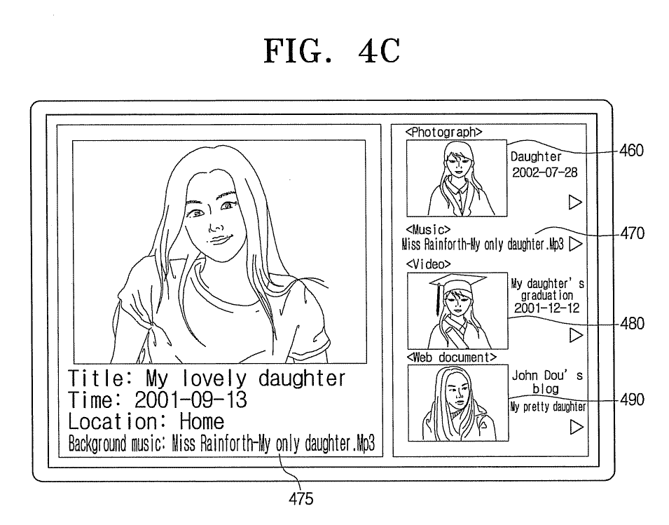

A related content search screen according to an embodiment of the present invention will be explained with respect to FIGS. 4A-4C. FIGS. 4A to 4C show an example of a screen in which a content generating window and a related content window are displayed.

FIG. 4A shows a screen provided for a user to generate a photograph content. As illustrated in FIG. 4A, the screen includes a first information window 400 (content generating window) 400 to display multimedia content being currently generated, and a second information window (related content window) 450 to display related multimedia content. The content generating window 400 displays a photograph, under which a title of the photograph, and the time and place of taking the photograph, are written by the user.

The related content window 450 displays content related to the content currently being generated in the content generating window 400. The related content window 450 may categorize the related contents in several types, such as photograph, music, video and web document. The related content window 450 displays the most-relevant contents from each of the content types. The related content window 450 may display the remaining less-relevant content in response to a click on an arrow indicated beside the most relevant content.

If the related content includes the photograph 460 and the video 480, the related content window 450 displays thumbnails, titles and dates of taking the photograph 460 or the video 480. If the related content is the photograph 460, the photograph may be reduced in size and transformed into a thumbnail. If the related content is the video 480, a portion of the video 480, such as the beginning part, may be captured and displayed, or the video 480 may be indicated as a thumbnail. If the related content is music, the related content window 450 displays a music file name. Alternatively, the related content window 450 may display the title and singer of the music.

If the related content is a web document 490, the related content window 450 may display a photograph, source, and title of the web document 490. The related content window 450 may also display a keyword to indicate the web document 490, or the entire pages of the web document 490 in a reduced size, such as a one-page-long document or a thumbnail.

FIG. 4B shows a screen that appears in response to clicking on a related photograph 460 of the related content window 450 of FIG. 4A. If a user clicks the related photograph 460 of the related content window 450, a full-size version 465 of the related photograph 460 is displayed for a better view.

The user may click on other related content. If the user clicks related music 470 of the related content window 450 of FIG. 4A, related music 470 may be replayed. Alternatively, a portion of the related music 470 may be replayed. If the user clicks related video 480 of the related content window 450 of FIG. 4A, the related video 480 may be replayed. Alternatively, a portion of the related video 480 may be replayed. If the user clicks a related web document 490 of the related content window 450 of FIG. 4A, the hyperlinked full-sized web document 490 may be accessed.

FIG. 4C shows an example of the content generating window 400 as the user drags the related music 470 of the related content window 450 of FIG. 4A to the content generating window 400. If the user drags the related music 470 of the related content window 450 to the content generating window 400, the related music 470 is added to the currently generated content. Accordingly, the related music 470 is added and used as the background music 475. Alternatively, the user may drag other types of content, such as the related photograph 460, the video 480, and the web document 490 of the related content window 450 of FIG. 4A to add to the content generating window 400.

As explained above, the user may use related content regarding content the user is currently generating. Another example, in which a user generates a text in the user's blog, will be explained below.

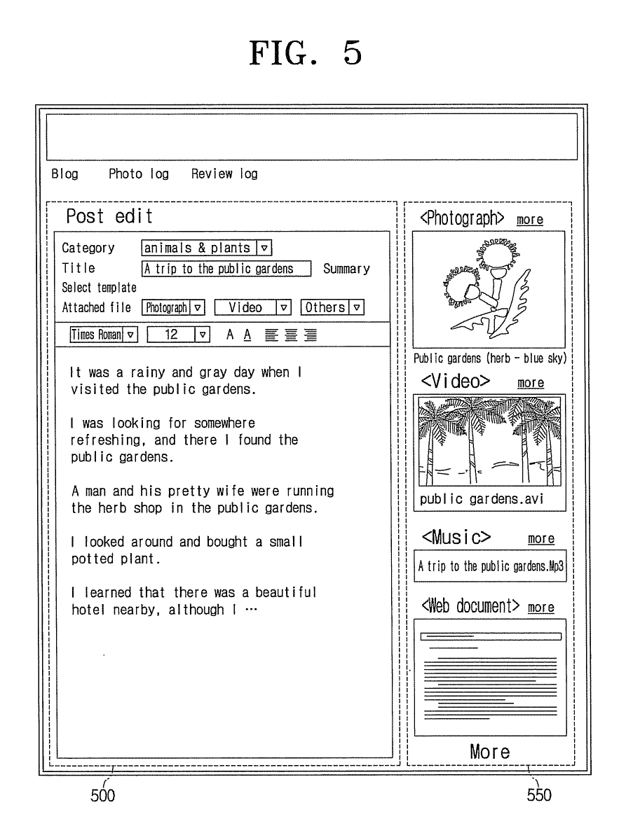

FIG. 5 shows an example in which the related content are displayed regarding the content being currently generated, according to another embodiment of the present invention. The screen includes a content generating window 500 and a related content window 550.

While the user is generating a document on the content generating window 500, the related content window 550 displays content related to the currently generated document. Therefore, it is possible to add the related content displayed in the related content window 550 to a blog document currently being written.

For example, FIG. 5 shows a text currently being generated on a blog under the title of “I went to the public gardens,” in which the related contents, such as photograph “herb—blue sky,” video of the public gardens, music “A trip to the public gardens,” and related web document, are searched and displayed along with the text currently being generated. The user may add the photograph “herb—blue sky” to the currently generated document by dragging the photograph to the content generating window 500. The screen for searching the related content regarding the content being currently generated has been explained above with reference to FIGS. 4A to 5.

While the embodiments explained above employ the PC 200 connected to the Internet 150, other alternatives are possible. Any multimedia device connectable to a network or containing internal storage media may be used, according to other aspects of the present invention. For example, the instead of (or in addition to) the PC 200, the multimedia device may be a mobile phone, a PDA (personal digital assistant), a digital camera, a camcorder, a personal entertainment device, or an information terminal.

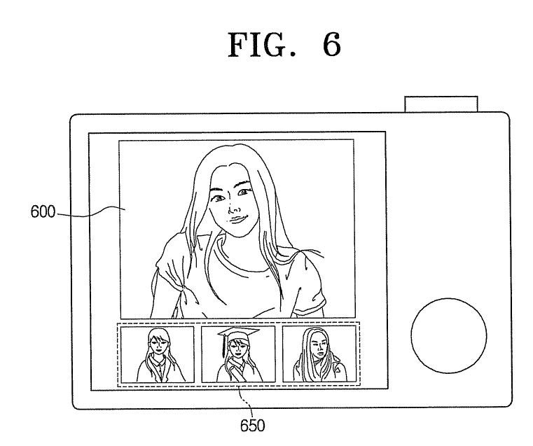

An implementation of a digital camera according to yet another embodiment of the present invention will be explained. FIG. 6 shows an example of displaying other content related to a digital camera photograph currently being viewed on a digital camera. A screen of the digital camera may include a photograph viewing window 600 and a related photograph window 650. The photograph viewing window 600 may display a currently taken photograph or stored photographs.

The related photograph window 650 displays photographs related to the photograph currently displayed on the photograph viewing window 600, by searching and retrieving the related photographs from an internal memory of the digital camera or a connected network. With respect to the photograph taken by a digital camera, the related digital camera photographs may be searched using attribute data, such as a file name or photographing place indicated on the photograph viewing window 600. As a result, the related digital camera photographs are searched and displayed.

In the embodiments explained above, documents, photographs, videos and music were implemented as examples of the content. However, other aspects of the invention may employ other types of content.

As explained above, according to aspects of the present invention, a method for providing a graphic user interface (GUI) to display contents related to currently generated content and a multimedia apparatus incorporating the same are provided. As a result, user can check the related other contents more easily, when generating content.

Because the other related content is concurrently displayed on a screen along with the content currently being generated by the user, the user can check the related content almost simultaneously as the user generates the content. Furthermore, because the related content is automatically searched as the user generates content, the user may conveniently adds the related content to the content the user is currently generating.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A multimedia apparatus comprising:
a display unit to display multimedia information, including a first information window to display first multimedia information and a second information window to display second multimedia information;
a control unit to search for the second multimedia information as related information of the first multimedia information and to display the second multimedia information on the second information window while a user edits or generates the first multimedia information; and
a storage unit to store the multimedia information.

2. The multimedia apparatus of claim 1, wherein the first multimedia information and the second multimedia information comprise at least one of still image, video, audio, or text.

3. The multimedia apparatus of claim 1, wherein the second information window displays attribute data to represent attributes of the multimedia information.

4. The multimedia apparatus of claim 1, wherein the control unit adds the second multimedia information to the first multimedia information according to a control command of the user.

5. A multimedia apparatus comprising:
a display unit to display multimedia information, including a first information window to display first multimedia information and a second information window to display second multimedia information related to the first multimedia information;
a network interface unit connectable to a network;
a control unit to search for the second multimedia information, which is related to the first multimedia information, via the network interface unit, and to display the second multimedia information on the second information window while a user edits or generates the first multimedia information; and
a storage unit to store the multimedia information.

6. The multimedia apparatus of claim 5, wherein the control unit comprises a search engine unit to search for the second multimedia information.

7. A method of providing a graphic user interface (GUI) to display multimedia information, comprising:
displaying a first information display region to display first multimedia information;
displaying a second information display region to display at least one second multimedia information related to the first multimedia information while a user edits the first multimedia information; and
displaying the at least one second multimedia information on the second information display region.

8. A method for displaying multimedia information comprising:
displaying first multimedia information on a first information display region;
searching for second multimedia information related to the first multimedia information while a user edits the first multimedia information; and
displaying the second multimedia information on a second information display region.

9. A method for providing a graphic user interface (GUI) comprising:
generating first content;
automatically searching for content related to the first content via a storage medium or a network, while the first content is being generated; and
displaying the related content while the first content is being generated.

10. The method of claim 9, wherein the displaying comprises displaying the first content currently being generated along with the related content on the same screen.

11. The method of claim 9, wherein the searching comprises categorizing the related content obtained from the storage medium or through the network into content types and determining content relevant to the first content in each content type.

12. The method of claim 9, wherein the searching comprises searching for the related content via the storage medium or the network after a predetermined interval.

13. The method of claim 9, wherein the displaying comprises categorizing the searched related contents according to content types.

14. The method of claim 9, wherein the searching comprises searching for the related content via the storage medium or the network using a keyword or attribute data of the first content.

15. The method of claim 9, wherein if the first content is a photograph or video, the searching comprises searching for the related content via the storage medium or the network, using image characteristic data including at least one of brightness, color, area matching, or feel of material.

16. The method of claim 9, wherein if the related content is photographs, the displaying comprises displaying related thumbnails corresponding to the related content.

17. A multimedia apparatus comprising:
a network interface unit connectable to a network;
a storage unit to store a multimedia file; and
a control unit to display first content concurrently with content related to the first content currently being generated, via the storage unit or the network connected through the network interface.

18. The multimedia apparatus of claim 17, wherein the control unit displays the related content on the same screen as the first content that is currently being generated.

19. The multimedia apparatus of claim 17, wherein the control unit searches for the related content by categorizing the related content obtained from the storage unit or the network according to content type and determining which of the related content is most relevant to the first content for each content type.

20. The multimedia apparatus of claim 17, wherein the control unit searches for the related content via the storage unit or the network after a predetermined time interval.

21. The multimedia apparatus of claim 17, wherein the control unit categorizes the related content according to content type and displays the result.

22. The multimedia apparatus of claim 17, wherein the control unit searches for the related content via the storage unit or the network using a keyword or attribute data of the first content.

23. The multimedia apparatus of claim 17, wherein if the first content is a photograph or video, the control unit searches for the related content via the storage medium or through the network using image characteristic data including at least one of brightness, color, area matching, or feel of material.

24. The multimedia apparatus of claim 17, wherein if the related content is photographs, the control unit displays related thumbnails corresponding to the related content.

25. A multimedia apparatus to edit or generate content, the apparatus comprising:
a display unit to display a first window containing first content and a second window containing second content related to the first content;
a storage unit to store the first content;
a network interface to enable access to a network;
a controller to display the first content, to automatically search the storage unit or the network for the second content while a user edits or generates the first content, to display the second content while the user edits the first content, and to enable the user to edit or generate the first content using the second content.

26. The multimedia apparatus of claim 25, wherein the controller displays the second content by content type.

27. The multimedia apparatus of claim 26, wherein the content types include photographs, video, and text.

28. The multimedia apparatus of claim 26, wherein the controller displays related information about the second content along with the second content.

29. The multimedia apparatus of claim 25, wherein the multimedia apparatus is a digital camera.

30. The multimedia apparatus of claim 25, wherein the controller displays the most relevant second content, and displays remaining less relevant second content upon the user's command.

31. The multimedia apparatus of claim 25, wherein the first content is a blog document

32. A method of dynamically editing or generating content, the method comprising:
displaying first content;
automatically searching for second content related to the first content while a user edits or generates the first content; and
displaying the second content while the user edits the first content so as to enable the user to edit or generate the first content using the second content.

33. The method of claim 32, wherein the displaying of the second content comprises displaying the second content by content type.

34. The method of claim 33, wherein the content types include photographs, video, and text.

35. The method of claim 32, further comprising displaying related information about the related content.

36. The method of claim 32, wherein the displaying of the second content comprises:
displaying the most relevant second content; and
displaying remaining less relevant second content in response to a command from the user.
